(19) United States
(12) Patent Application Publication
(10) Pub. No.: US 2002/0172256 A1
(43) Pub. Date: Nov. 21, 2002

(54) Method and device for detecting the temperature of a hydraulic braking system in a motor vehicle

(76) Inventor: Jingsheng Yu, Ludwigsburg (DE)

Correspondence Address: KENYON & KENYON, ONE BROADWAY, NEW YORK, NY, 10004, US

(21) Appl. No.: 09/958,550

(22) PCT Filed: Jan. 7, 2001
(86) PCT No.: PCT/DE01/00176

(51) Int. Cl. G01K 7/00; G01K 1/14; G01K 13/00

(52) U.S. Cl. 374/141; 374/163

(57) ABSTRACT

A method of determining the temperature of a hydraulic brake system of a motor vehicle is described, in which the temperature of the hydraulic pump is determined with the help of a model and by measuring the motor voltage (Uₘ) and the power supply voltage after turning it on. The model has a state observer with which a temperature-dependent estimator is formed for the estimated temperature of the pump motor or the hydraulic pump. The estimator is determined at a defined time after turning on the power supply voltage, and the temperature of the hydraulic pump (1) is determined with the help of an empirical comparison table or curve. The estimated temperature or the change in temperature is used to correct or improve on the brake pressure control of the hydraulic brake system, in particular in the case of an anti-skid system (ABS) and/or an anti-spin control (ASC).

### BACKGROUND INFORMATION

The present invention is based on a method of determining the temperature of a hydraulic brake system of a motor vehicle according to the definition of the species of the main claim. German Patent Application 196 51 154 A1 has already described a method and a device for controlling a brake system in which an electrically operated pump motor a hydraulic pump of a brake system is turned on and off. The increase in temperature which occurs during operation is not measured directly but instead is estimated from the motor voltage characteristic at the output of the pump motor after turning off the hydraulic pump. Another parameter used to estimate the temperature is the motor rpm which is monitored when the pump is turned off. The estimated temperature of the hydraulic unit or the brake system is used to improve the pressure control for an anti-skid system (ABS), for example.

However, it has been found that an estimate of the brake system temperature from the voltage characteristic of the pump motor after turning it off is relatively inaccurate and does not adequately detect a dynamic pressure buildup at low temperatures, for example.

### ADVANTAGES OF THE INVENTION

The method according to the present invention for determining the temperature of a hydraulic system of a motor vehicle having the characterizing features of the main claim, however, has the advantage that instead of measuring the voltage characteristic of the pump motor after it has been turned off, a model is formed for determining, with the help of the power supply voltage and the motor voltage, the temperature of the pump motor after turning it on. Changes in temperature can be detected better and more accurately through the start-up behavior of the pump motor with the hydraulic pump than by measuring the voltage characteristic when turning off, taking into account individual pump tolerances and changes in pressure in the hydraulic system, because the voltage does not depend on the temperature alone.

Advantageous refinements of and improvements on the method characterized in the main claim are possible through the measures characterized in the dependent claims. It is especially advantageous that the model includes a state observer which with its equations simulates an estimator for the temperature of the hydraulic pump from the input parameters without any additional sensors.

It is especially advantageous that the estimator is determined after a defined period of time. This period of time is selected so that there is no change in temperature, if possible.

The respective temperature can be determined most easily by a simple comparison of the estimator thus determined with stored table values or a curve, because it is easy to determine these values empirically by measurement.

It is also advantageous to simulate the values thus determined for the temperature as a function, because a function can be interpreted even more easily by computer and requires less memory. It has been found to advantage that a second-order polynomial is a good approximation.

Since this method can easily be embedded in a software program, this advantageously yields an inexpensive method of implementation. Furthermore, a program can be adapted more easily than a hardware implementation.

Advantages are also offered by a device designed according to this method for a brake system, because the method can easily be integrated into the existing brake system programs. In this way, the required brake pressure can be controlled better and to advantage, taking into account the temperature of the brake system. This is important in particular in the case of an anti-skid system (ABS) or for anti-spin control (ASC) and the like.

### DRAWING

One embodiment of the present invention is illustrated in the drawing and explained in greater detail in the following description.

FIG. 1 shows a block diagram,

FIG. 2 shows a diagram with voltage curves, and

FIG. 3 shows a diagram with temperature curves.

### DESCRIPTION OF THE EXEMPLARY EMBODIMENT

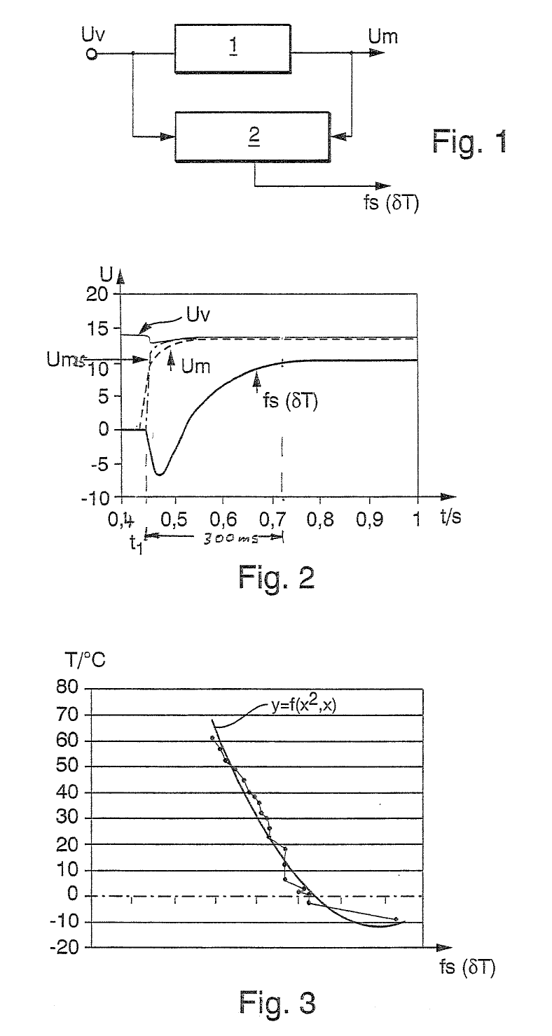

FIG. 1 shows a circuit diagram of a block diagram having a state observer designed as a closed loop. In this block diagram, power supply voltage U_{V} is sent to a pump motor 1 and motor voltage Uₘ is detected at the output of pump motor 1. The voltages are preferably measured and stored as their time characteristic. State observer 2, arranged in parallel with pump motor 1, to which the power supply voltage U_{V} and the motor voltage Uₘ are supplied. The state observer 2 forms from this an estimator f_{S} (δT) for a temperature-dependent term of an assumed simulation model, which is explained in greater detail below. This principle of modeling with a state observer is known in the theory of control engineering per se, where it is used to determine temperature as an influencing quantity. The modeling is based on the assumption that because of the tight mechanical coupling, heat transfer between pump motor 1 and the rest of the hydraulic unit is so good that a linear correlation can be assumed. The correlation with temperature T measured at pump motor 1 or the hydraulic unit may thus be compiled in the form of a table or a curve for an estimator f_{S} (δT) to be formed.

The functioning is explained in greater detail on the basis of FIGS. 2 and 3.

An equation

$$\frac{ⅆ x}{ⅆ t} = f ( {T}_{0} ) + {f}_{s} ( δ T ) \qquad ( 1 )$$

is formed for the dynamic model of pump motor 1. First term f(T₀) is a term that is not dependent on temperature and is based, for example, on room temperature or any other temperature such as the zero point. The simplest way to determine this first term is by an empirical measurement of the voltage characteristic of motor voltage Uₘ at a defined temperature T₀, for example.

Second term f_{S}(δT) in the above equation is the actual disturbance model which varies as a function of change in temperature δT. This term is at first unknown and is determined by the state observer according to the following description.

In the model according to equation (1), the state observer is defined as follows:

x=A*x+b*u

y=C*x (2)

where A, b and C are system parameters. Parameters u and y characterize the measurement signals of the pump motor voltage and the power supply voltage, and x is a state vector containing function f_{S}(δT) as one of the state variables. These assumptions are valid for a limited estimation time tₛ during which the state observer can be assumed to be constant. It has been found experimentally that estimation time tₛ may amount to a maximum of 300 ms, i.e., the temperature remains approximately constant up to 300 ms. Estimator f_{S}(δT) can thus be determined with sufficient accuracy 300 ms after turning on power supply voltage U_{V}.

The simplest method of implementing model equations (2) for the state observer is with a software program. Since today's brake systems already have program-controlled computers, an existing program can be advantageously expanded accordingly. Thus according to FIG. 2, this program supplies a value for estimator f_{S}(δT) 300 ms after the turn-on t₁ of power supply voltage U_{V}, for example. This value is a reference voltage value which must be converted to a corresponding temperature. This is done by using a stored table or with the help of the diagram in FIG. 3, where the correlation between estimator f_{S}(δT) and the temperature of the brake system (pump motor 1) was determined experimentally at various temperatures. The dotted-line curve shows estimator f_{S}(δT) for the individual measured points. To facilitate processing of this measured curve by computer, it has been approximated with a second-order polynomial:

y=f(x^{2,}x).

This polynomial is now used as an approximation function for the estimator for the temperature determination.

In addition, FIG. 2 also shows the curve for the estimated motor voltage as a function of time.

Power supply voltage U_{V} drops slightly after turning on motor voltage Uₘ at time t₁ and then it remains stable. After being turned on, motor voltage Uₘ increases after a time constant which is determined by pump motor 1, until reaching the value of power supply voltage UV. The curve for estimator f_{S}(δT) drops at first and then increases asymptotically. After a short period of time, e.g., approx. 300 ms, the value for estimator f_{S}(δT) is stable.

As also shown by the diagram in FIG. 3, the temperature difference between the measured temperature and the temperature estimated by the polynomial is less than 10° C. This result is sufficient, for example, for braking control (ABS, ACS) or dynamic driving control (DDC) of a vehicle and constitutes a good improvement in comparison with the known method, in particular since no additional sensor is needed for measuring the temperature.

What is claimed is:

1. A method of determining the temperature of a hydraulic brake system of a motor vehicle, an electric motor-driven hydraulic pump of the brake system being turned on and off for a period of time, and the temperature of the pump motor (1) being derived from the characteristic of the motor voltage (Uₘ),
wherein the motor voltage (Uₘ) and the power supply voltage (U_{V}) are measured after turning on the pump motor (1), and the temperature (δT) of the pump motor (1) can be determined from the motor voltage (Uₘ) and the power supply voltage (U_{V}) by using a model containing a temperature-dependent estimator f_{S}(δT).

2. The method according to claim 1,
wherein the model is formed according to the equation
$$\frac{ⅆ x}{ⅆ t} = f ( {T}_{0} ) + {f}_{s} ( δ T )$$
where f(T₀) is a term which is independent of temperature, and (f_{S}(δT)) is a temperature-dependent disturbance model.

3. The method according to claim 1 or 2,
wherein the model has a state observer which is formed according to the following equations:
x=A*x+b*u
y=C*x
where A, b and C are system parameters, u and y each contain the measured values for the power supply voltage and the pump voltage, and x is a state vector containing the temperature-dependent estimator (f_{S}(δT)) as the state variable.

4. The method according to one of claims 1 through 3,
wherein the estimator (f_{S}(δT)) is determined after a defined period of time, preferably 300 ms.

5. The method according to claim 4,
wherein the temperature of the pump motor (1) is determined on the basis of a table with respect to the value determined for the estimator (f_{S}(δT)).

6. The method according to one of the preceding claims,
wherein the temperature-dependent comparison values for the estimator are stored in the form of a table or a curve.

7. The method according to claim 6,
wherein the comparison values for the temperature determined empirically in the table or for the curve.

8. The method according to one of claims 4 through 7,
wherein the curve is simulated by regression, preferably as a second-order polynomial.

9. The method according to one of the preceding claims,
wherein the estimation model is designed in the form of a software program.

10. A device for carrying out the method according to one of the preceding claims, wherein a brake system of a motor vehicle having an anti-skid system (ABS) or an anti-spin control (ASC) has a program with which the temperature of the pump motor (1) of the hydraulic system can be estimated.

11. The device according to claim 10,
wherein the brake system is designed to use the temperature thus determined for correcting the brake pressure.
